(19) United States
(12) Patent Application Publication
(10) Pub. No.: US 2014/0178641 A1
(43) Pub. Date: Jun. 26, 2014

(54) METHODS OF COATING A SURFACE AND ARTICLES WITH COATED SURFACE

(71) Applicant: GENERAL ELECTRIC COMPANY, Schenectady, NY (US)

(72) Inventors: Luc Stephane Leblanc, Clifton Park, NY (US); James Anthony Ruud, Delmar, NY (US); Kevin Paul McEvoy, Ballston Spa, NY (US); Ambarish Jayant Kulkarni, Glenville, NY (US)

(73) Assignee: GENERAL ELECTRIC COMPANY, Schenectady, NY (US)

(21) Appl. No.: 13/723,301

(22) Filed: Dec. 21, 2012

(51) Int. Cl. C23C 4/00; B32B 5/16

(52) U.S. Cl. CPC C23C 4/005; B32B 5/16
USPC 428/143; 427/448; 427/447

(57) ABSTRACT

A method of coating a surface is provided. The method comprises feeding a feedstock to a thermal spray torch, the feedstock comprising a liquid, disposing the feedstock on a substrate by thermal spray under conditions selected to produce a textured surface comprising a hierarchical structure, wherein the hierarchical structure comprises agglomerations of at least partially melted and solidified particles derived from the feedstock with individual at least partially melted and solidified particles derived from the feedstock disposed on a surface of the agglomerations; and applying a surface energy modification material over the textured surface. An article comprising a component having a coated surface is also provided.

### STATEMENT REGARDING FEDERALLY SPONSORED RESEARCH & DEVELOPMENT

This invention was made with Government support under contract number 70NANB7H7009 awarded by the U.S. NIST Advanced Technology Program. The Government has certain rights in the invention.

### FIELD

The invention relates generally to methods for coating a surface and articles having the coated surface. More particularly, the invention relates to methods for coating a surface using a thermal spray technique.

### BACKGROUND

Hydrophobic and super-hydrophobic surfaces are desirable in numerous applications, such as windows, clothing, textiles, medical instruments, automotive and aircraft parts, cooking utensils, DVD disks, and similar applications. For applications requiring wetting resistance, hydrophobic and super-hydrophobic surfaces promote the formation of liquid drops with a high contact angle, which thus minimizes contact area with the solid surface. “Hydrophobic” materials have contact angle with water generally at or above 90 degrees; wherein the “super-hydrophobic” materials are often described as having a contact angle greater than 150 degrees.

Typically, polymers such as tetrafluoroethylene, silanes, waxes, polyethylene, and propylene materials are known to be hydrophobic, though the polymers have limitations in temperature resistance and durability that can limit their applications. Ceramic materials are typically superior to polymers in many aspects related to durability, ease of manufacturing, high environmental resistance, good mechanical properties. However, with only a few exceptions, the large majority of ceramic materials, are not generally hydrophobic.

Texturing or roughening the surface can change the contact angle of a liquid on a surface, and change the degree of hydrophobicity. Altering the surface chemistry in order to achieve hydrophobicity typically involves coating the surface with a low surface energy coating. Typically super-hydrophobic surfaces have been created by changing both surface chemistry and surface texturing.

Most of the existing techniques for altering the wetting resistance of a surface suffer from certain drawbacks, such as processes that are time consuming, difficult to control, expensive or ineffective in producing films with sufficient durability, and are usually not scalable to large surface areas. Therefore, there remains a need in the art for a method of coating a surface and an article with a coated surface that provides lower liquid wettability and good mechanical properties, and is amenable to coating processing by an inexpensive, easy, and effective means.

### BRIEF DESCRIPTION

In one embodiment, a method of coating a surface is provided. The method comprises feeding a feedstock to a thermal spray torch, the feedstock comprising a liquid; disposing the feedstock on a substrate by thermal spray under conditions selected to produce a textured surface comprising a hierarchical structure, wherein the hierarchical structure comprises agglomerations of at least partially melted and solidified particles derived from the feedstock with individual at least partially melted and solidified particles derived from the feedstock disposed on a surface of the agglomerations; and applying a surface energy modification material over the textured surface.

In another embodiment of a method of coating a substrate, the method comprises feeding a feedstock to a thermal spray torch, the feedstock comprising a liquid carrier and a plurality of ceramic particles disposed in the carrier, wherein at least 50% of the particles in the plurality have a diameter less than about 5 microns; disposing the feedstock on the substrate by a suspension plasma spray process under conditions selected to produce a textured surface comprising a hierarchical structure, wherein the hierarchical structure comprises agglomerations of at least partially melted and solidified ceramic particles derived from the feedstock with individual at least partially melted and solidified particles derived from the feedstock disposed on a surface of the agglomerations; and applying a low surface energy modification material over the textured surface.

In yet another embodiment, an article is provided. The article comprises a component having a coated surface comprising a coating, wherein the coating comprises a first layer, wherein the first layer comprises a textured surface comprising a hierarchical structure comprising agglomerations of at least partially melted and solidified particles derived from a feedstock with individual at least partially melted and solidified particles derived from the feedstock disposed on a surface of the agglomerations; and a second layer, wherein the second layer comprises a low surface energy material disposed on the textured surface.

### DRAWINGS

These and other features, aspects, and advantages of the present invention will become better understood when the following detailed description is read with reference to the accompanying drawing, wherein:

FIG. 1 is a schematic drawing of primary feature and secondary feature of a coated surface, according to one embodiment of the invention.

FIG. 2A is a process map of coating a surface, according to one embodiment of the invention.

FIG. 2B is a schematic drawing of an article comprises a first layer of coating and a second layer of coating disposed on a surface, according to one embodiment of the invention.

FIG. 3 is an image of a static contact angle of water on a coated surface, according to one embodiment of the invention.

FIGS. 4 (A-D) are images of various coating structures showing different textures on application of plasma spray and low surface energy modification material with higher stand-off distance, according to one embodiment of the invention.

FIGS. 5 (A-C) are images of various coating structures showing different textures on application of plasma spray and low surface energy modification material with lower stand-off distance, according to one embodiment of the invention.

FIG. 6A is an image of a pair of coated condenser tubes, FIG. 6B shows drop wise condensation on a tube surface, and FIG. 6C is a heat-flux data for a tube subjected to drop wise condensation for two hours, according to one embodiment of the invention.

FIG. 7A shows wetting of water on a textured surface as a control, and FIG. 7B shows wetting resistant behavior for water of a surface coated with surface modification material, according to one embodiment of the invention.

FIG. 8 is an illustration of a surface with a composite coating that comprises both hydrophilic and hydrophobic areas, forming oil-water interface, according to one embodiment of the invention.

### DETAILED DESCRIPTION

Embodiments of the present invention are directed to a method of coating a surface, and an article comprising the coated surface.

In the following description and the claims that follow, whenever a particular aspect or feature of an embodiment of the invention is said to comprise or consist of at least one element of a group and combinations thereof, it is understood that the aspect or feature may comprise or consist of any of the elements of the group, either individually or in combination with any of the other elements of that group. Similarly, the singular forms “a”, “an” and “the” include plural referents unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about” may not be limited to the precise value specified, and may include values that differ from the specified value. In at least some instances, the approximating language may correspond to the precision of an instrument for measuring the value. In the present discussions it is to be understood that, unless explicitly stated otherwise, any range of numbers stated during a discussion of any region within, or physical characteristic of, is inclusive of the stated end points of the range.

The “wetting resistance” of a surface is determined by observing the nature of the interaction occurring between the surface and a drop of a reference liquid disposed on the surface. The droplets, upon contact with a surface, may initially spread over a relatively wide area, but often contract to reach an equilibrium contact area. Droplets contacting a surface having a low wetting resistance to the liquid tend to remain spread over a relatively wide area of the surface (thereby “wetting” the surface). In the extreme case, the liquid spreads into a film over the surface. On the other hand, where the surface has a high wetting resistance for the liquid, the liquid tends to contract to well-formed, ball-shaped droplets. In the extreme case, the liquid forms nearly spherical drops that either roll off of the surface at the slightest disturbance or lift off from the surface due to impact momentum. As used herein, the term “wetting-resistant” refers to surfaces that are resistant to wetting by reference liquids.

As used herein, the term “contact angle” is referred to as the angle a stationary drop of a reference liquid makes with a horizontal surface upon which the droplet is disposed. Because wetting resistance depends in part upon the surface tension of the reference liquid, a given surface may have a different wetting resistance (and hence form a different contact angle) for different liquids. As used herein, the term “advancing contact angle” is the angle when a sessile drop has the maximum volume allowable for a liquid-solid interfacial area at thermodynamic equilibrium. The term “receding contact angle” is the angle when a sessile drop has the minimum volume allowable for a liquid-solid interfacial area at thermodynamic equilibrium. The difference between the maximum advancing contact angle and receding contact angle values is called the contact angle hysteresis.

Contact angle is used as a measure of the wettability of the surface. If the liquid spreads completely on the surface and forms a film, the contact angle is 0 degree. As the contact angle increases, the wetting resistance increases. The terms “hydrophobic” and “super-hydrophobic” are used to describe surfaces having very high wetting resistance to water. As used herein, the term “hydrophobic” will be understood to refer to a surface that generates a contact angle of greater than about 90 degrees with water. As used herein, the term “super-hydrophobic” will be understood to refer to a surface that generates a contact angle of greater than about 150 degrees with water.

The extent to which a liquid is able to wet a surface plays a significant role in determining how the liquid and the surface will interact with each other. A high degree of wetting results in relatively large areas of liquid-surface contact, and is desirable in applications where a considerable amount of interaction between the two surfaces is beneficial, such as, for example, adhesive and coating process applications. Conversely, for applications requiring low solid-liquid interaction, the resistance to wetting is generally kept as high as possible in order to promote the formation of liquid drops having minimal contact area with the solid surface.

As used herein, the term “derived from feedstock” means that one or more particles are obtained from a liquid feedstock. In one embodiment, the feedstock is a particle precursor which decomposes during the spray process to form particles which are deposited on the surface. For example, the liquid is pyrolized to form particles that are deposited and form a textured coating with fine particles. In another embodiment the liquid feedstock is a suspension of particles in a liquid which releases the particles during the spray process upon evaporation of the liquid to deposit particles on the surface. The term “derived from” is used herein to refer to both of these cases. In another embodiment, the liquid feedstock is a combination of a particle precursor and a suspension.

The term “low surface energy material” as used herein means a material with surface energy less than about 35 mJ/m² and typically exhibits hydrophobic behavior. The materials having surface energy less than about 20 mJ/m² are highly hydrophobic and exhibit contact angles with water greater than 90 degrees. Non-limiting examples of low surface energy materials are polytetrafluoroethylene PTFE, polydimethylsiloxane PDMS, paraffin wax, polypropylene, octadecyltrichlorosilane, polyethylene, polystyrene, and fluoroalkysilanes.

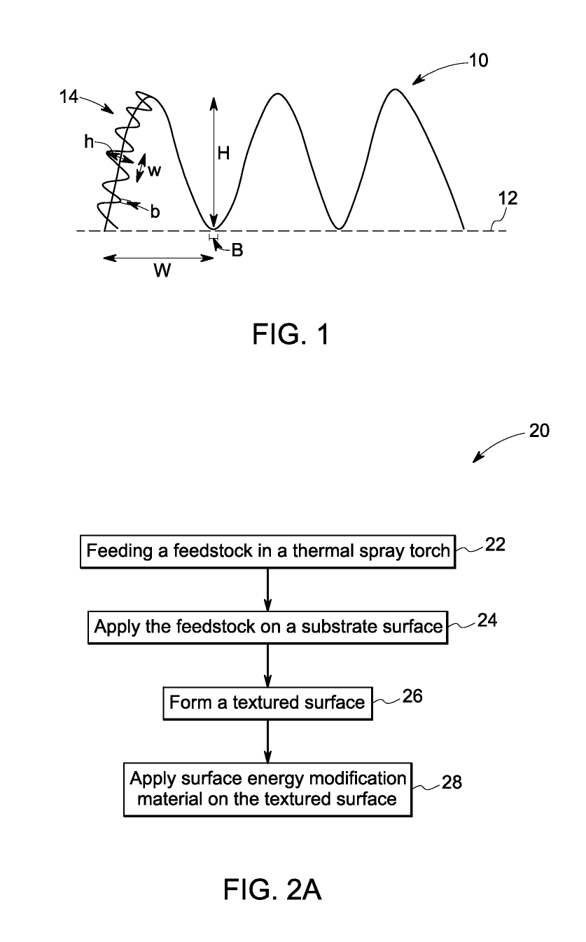

As used herein, the term “hierarchical structure” is referred to as a structure which comprises primary features and secondary features, wherein the secondary features are superimposed on the primary feature and form a texture over the surface. With reference to FIG. 1A, the primary feature 10 may comprise a height dimension (H), which represents the mean height of an elevation above a mean surface level 12 of the textured surface. In some embodiments, the mean height H above a mean surface level of the textured surface is at least about 1 micron. Each of the primary features comprises a width (W). In one or more embodiments, a width (W) of the primary feature is in a range from about 2 μm to 200 μm. In another embodiment, the width (W) of the primary feature is in a range from about 3 μm to 150 μm. In another embodiment, the width (W) of the primary feature is in a range from about 5μm to 50 μm. Two of the primary features are disposed with a spacing dimension (B). Spacing dimension B is defined as the distance between the edges of two nearest elevations. In one or more embodiments, the spacing dimension (B) of the primary feature is less than about 50 μm. In other embodiment, the spacing dimension (B) of the primary feature is less than about 10 μm. In other embodiments, the spacing dimension (B) of the primary feature is less than about 5 μm. As mentioned, the secondary features 14 are disposed on the primary features, wherein the secondary feature has a height (h), width (w) and spacing dimension (b). In some embodiments, the secondary feature has a height (h) in a range less than 5 μm, width (w) in a range of less than 5 μm and spacing dimension (b) less than 2 μm. In other embodiments, the secondary feature has a height (h) in a range less than 2 μm, width (w) in a range of less than 2 μm and spacing dimension (b) less than 2 μm.

The hierarchical structure may comprise one or more elevations, depressions or both. The elevations may include agglomerations of at least partially melted and solidified particles. “At least partially melted” as used herein means material that has had at least a portion melt during spray processing. The term also includes material that was completely molten at some point in the process.

Embodiments of a method of coating a surface are disclosed, wherein the method comprises feeding a feedstock to a thermal spray torch, the feedstock comprising a liquid, disposing the feedstock on a substrate by thermal spray under conditions selected to produce a textured surface comprising a hierarchical structure, wherein the hierarchical structure comprises agglomerations of at least partially melted and solidified particles derived from the feedstock with individual at least partially melted and solidified particles derived from the feedstock disposed on a surface of the agglomerations; and applying a surface energy modification material over the textured surface.

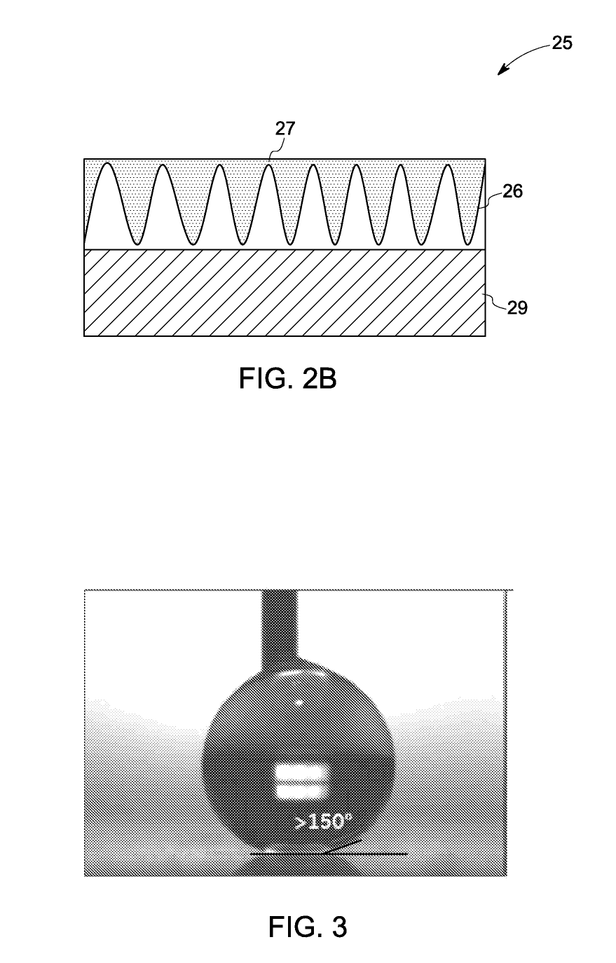

With reference to FIG. 2A, a method 20 of coating a surface according to an embodiment of the present invention is provided. The method 20 includes the steps of feeding a feedstock into a thermal spray torch 22, applying the feedstock on a substrate surface 24 to form a textured surface 26; and applying a surface energy modification material on the textured surface to form a hydrophobic coating 28.

With reference to FIG. 2B, the method 20 is employed to deposit a first layer of coating 26 on a surface of an article 29 to form a textured surface comprising hierarchical structure and a second layer of coating 27 is deposited on textured surface 26 using low surface energy modification material. The coated article 25 is described in detail later, with reference to FIG. 2B describing the article.

In one embodiment, the method comprises feeding a feedstock to a thermal spray torch and disposing the feedstock on a substrate by thermal spray under conditions selected to produce a textured surface comprising a hierarchical structure. The thermal spray forms a textured coating, interchangeably used herein as a first layer. The term, “conditions selected to produce texture surface” may refer to herein the processing conditions adopted to produce a textured surface. Such conditions may include feedstock injection to the process, which may use radial feeding, axial feeding, or a combination thereof, deriving particles from the interaction of the feedstock with the thermal spray process, heating and accelerating the derived particles to at least partially melt the particles by selecting spray parameters, depositing at least a portion of the heated and accelerated particles on a surface by selecting stand-off distance between the thermal spray torch and the surface, re-solidifying the at least partially melted particles to develop various hierarchical structures.

As noted, a thermal spray torch is used to dispose a feedstock on a surface, wherein the feedstock comprises a liquid carrier. In some embodiments, the feedstock comprises a liquid. The liquid feedstock may be a particle precursor which decomposes during the spray process to form particles, which are deposited on the surface by thermal spray under conditions selected to produce a textured surface. The liquid, for example, may be pyrolized and form particles that may be deposited to form a potentially textured coating with particles on the surface. Different experimental conditions are adopted to produce the textured surface. Such experimental conditions may further include pyrolizing at least a portion of the feedstock on the surface by selecting stand-off distance between the thermal spray torch and the surface to develop various hierarchical structures.

In some embodiments, the liquid carrier further comprises a plurality of particles disposed in the carrier. The liquid carrier and a plurality of particles form a suspension. The coating materials, such as particles, may be selected based on the nature of the intended application. For example, a coating material is selected to provide one or more functional features or structural features to a coated surface. The functional features of the coated surface may include, but are not limited to, wear resistance, temperature resistance, corrosion resistance, heat resistance, hydrophobicity, and hydrophilicity. The structural aspect of the coated surface may include a textured surface comprising one or more elevations, depressions, agglomerations or combinations thereof.

In some embodiments, the feedstock is disposed on a substrate to produce a textured surface comprising a hierarchical structure. The term “textured surface” and “textured surface comprising hierarchical structure” are used hereinafter interchangeably. The hierarchical structure comprises a plurality of surface texture features, including one or more elevations, such as agglomerations. In some embodiments, the hierarchical structure comprises agglomerations of at least partially melted and solidified particles derived from the feedstock with at least individual partially melted and solidified particles derived from the feedstock disposed on a surface of the agglomerations.

As noted, in some embodiments, the hierarchical structure comprises one or more agglomerations. The feedstock comprises liquid, or a suspension made of liquid and solid particles, which is injected within the plasma flow for deposition on a surface. The feedstock may be injected in the process axially (i.e., parallel to the flow), radially (i.e., across the flow) or a combination thereof. Injection may be performed using a liquid stream, or by an atomization process, or by any means allowing injection of the feedstock in the process. The liquid may be very quickly vaporized and the individual particles may form agglomerates, depending on the average size of the solid particle feedstock, materials properties of the solid particles, and process parameters. The individual particles or particle-agglomerates are heated and simultaneously accelerated towards the substrate surface to impact, spread and solidify to form a layer or coating. In embodiments of methods employing nano-sized particles, the evaporation of the solvent may lead to the formation of micron-sized aggregates made of nano-sized particles. In embodiments of methods employing micron-sized particles, the evaporation of the solvent may lead to the formation of aggregates constituted by a few particles. The aggregates may not be stable within the thermal spray process flow and disaggregate into smaller aggregates. The aggregates may fully or partially be vaporized or may fully or partially melt to form small particles which impact the surface and may partially spread and solidify to form flattened or partially flattened particles of equivalent diameters in the order of the micrometer or less.

In one or more embodiments, the hierarchical structure comprises agglomerations of at least partially melted and solidified particles. In one embodiment, the agglomerations comprise texture that is formed from at least partially melted and re-solidified particles. In more conventional coating processes, the particles of a feedstock at high temperature may impact, spread and solidify on the substrate to form flattened lamellae structure, thereby failing to form an effective texture. The flattened lamellae structure may be generated by fully melted particles after re-solidification. In the present method, the agglomerations provide a texture on the surface, wherein the texture may be formed from a combination of partially melted re-solidified particles and fully melted re-solidified particles. In some embodiments of the method, the individual partially melted and solidified particles of the feedstock are disposed on a surface of the agglomerations to form a hierarchical structure.

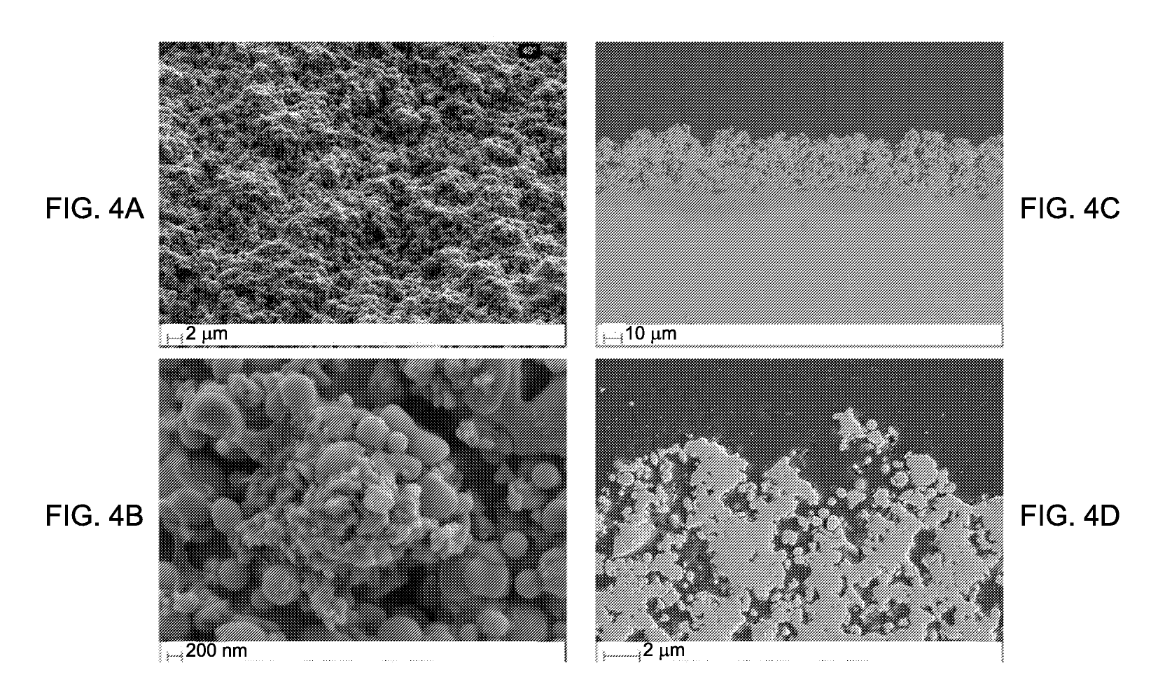

As noted earlier, the agglomeration may comprise both primary features and secondary features, as shown in FIG. 1 and FIGS. 4(A-D). The height H of the agglomeration above a mean surface level 12 of the textured surface is at least about 1 micron. In one or more embodiments, a size or width (W) of the agglomerations is in a range from about 5 μm to 50 μm. Various agglomerated features are disposed with a spacing dimension (B), which is the distance between the edges of two nearest elevations, such as a distance between two nearest agglomerated features.

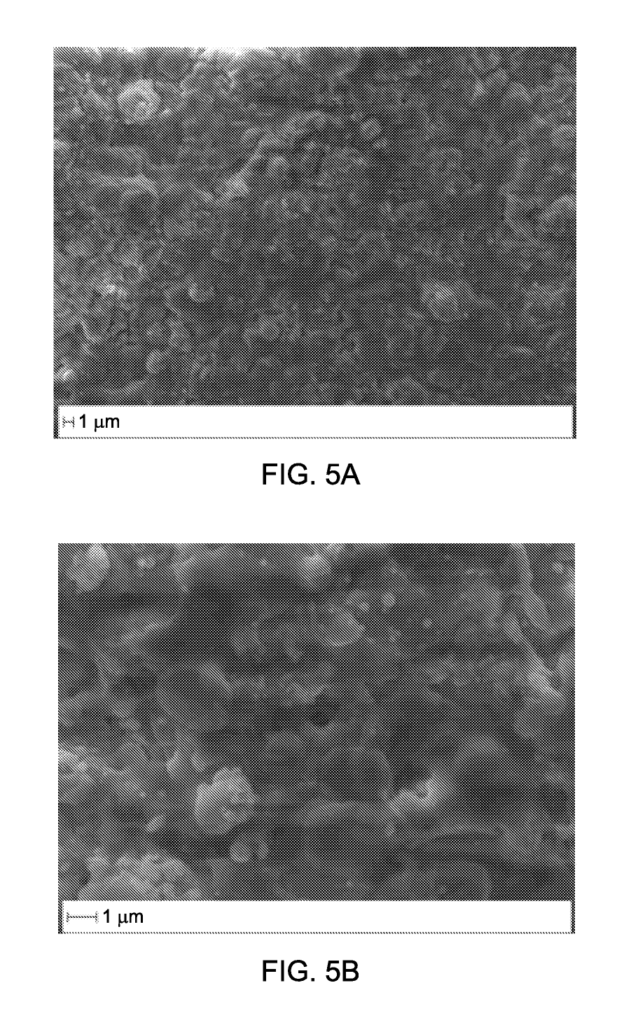

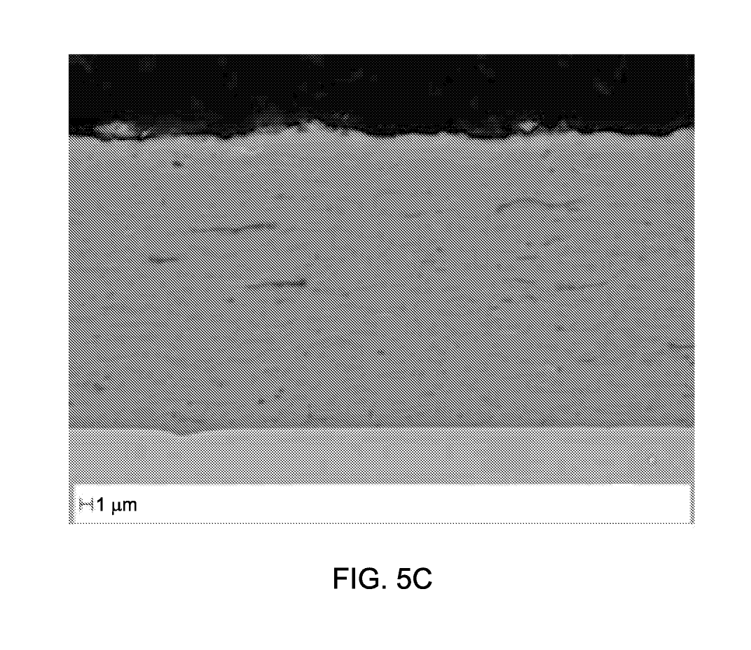

In some embodiments, the secondary features are formed from at least partially melted and solidified particles that have aspect ratios that approach unity. In contrast to conventional coatings, in which the surface features are smooth and are formed from particles which flatten upon impact into lamella with large width to thickness aspect ratios, the surface features of the invention are formed from particles with lesser deformation and lesser width to thickness aspect ratios. As shown in the top surface image FIG. 4B, the majority of the particles are spherical with an aspect ratio of unity and there is a notable lack of high aspect ratio disk-like particles. A presence of low aspect ratio particles such as particles with spherical shape disposed on the primary features may also be found. The particles may be present at various levels of depth in the image in FIG. 4B. In contrast, the non-hierarchical surface shown in FIG. 5B, comprises almost exclusively of flattened particles, with only an occasional low aspect ratio features.

In other embodiments, the secondary features 14 may comprise particles with both low aspect ratio and high aspect ratio which are distributed through the height of the primary features 10 (as shown in FIG. 1). In such embodiments, the primary feature height (H) is defined by both round and flattened particles which overlap incompletely to expose the edges of the particles. The secondary features 14 are defined by the scale of the edges of the overlapping particles and can have both disk-like and spherical particles, as shown in FIGS. 4B and 4D. The primary feature 10 comprises particle edges disposed at different heights relative to a mean surface 12. The particles may be deposited with low impact velocity and momentum which may allow accumulation of particles into a height of primary feature 10 and may form an aggregate, in some embodiments, larger than the particle size. In some embodiments, the height of the primary feature may be at least 1 micron with a secondary feature size of about 200 nm. In contrast, the coating-structure of FIG. 5A shows splats with high aspect ratio that have merged almost fully, producing a coating structure that substantially comprises completely overlapping particles with a notable lack of particle edges.

In some embodiments, the hierarchical structure further comprises one or more pores on the agglomerations. As used herein, the term “pore” refers to any depression on the surface, including naturally occurring pores and artificially occurring pores. In embodiments where the coating comprises one or more pores, a second layer of coating such as a surface energy modification material, which is disposed on the first layer of coating, may penetrate the microstructure via the pores, instead of residing only on the surface of the first layer. In this aspect, the durability of the coating may also be enhanced. In some embodiments, the agglomerations may comprise depressions or pores in a range of less than 90%.

Consideration of an average size of the solid particle for processing through the thermal spray process is desirable. The suspension is generally made of nano-sized particles or of micron-sized particles. In one or more embodiments, at least 50% of the particles in the plurality have a diameter less than about 5 microns. In one embodiment, at least 50% of the particles in the plurality have a diameter less than about 2 microns.

The particles of the feedstock may comprise an organic material or an inorganic material. In some embodiments, the feedstock comprises particles made of a ceramic, a metal, a polymer or combinations thereof. In certain embodiments, the feedstock comprises a metal, for example, metal comprising iron, nickel, cobalt, chromium, aluminum, copper, titanium, platinum, or any other suitable metallic element. The term “metal” as used herein encompasses elemental metallic materials, alloys, and other compositions comprising metals such as aluminides and other intermetallic compositions. The feedstock may comprise non-metallic materials, such as, for example, polymer, ceramics and semi-metals. Silicon is an example of a semi-metal; aluminum nitride, silicon carbide and titanium dioxide are examples of ceramics. Fluoroplastics such at polytetrafluoroethylene (PTFE) are examples of polymers.

In one embodiment, the particles of the feedstock comprise ceramic materials. The ceramic particles may constitute a first layer of coating on a surface by a thermal spray deposition. In some embodiments, the ceramic material constituting the surface includes, but is not limited to, an oxide, a mixed oxide, a nitride, a boride, a carbide or combinations thereof. The feedstock may comprise ceramic particles including zirconium oxide, aluminum oxide, titanium oxide, yttrium oxide, ytterbium oxide, silicon oxide, cerium oxide, lanthanum oxide, or any of the combinations. Non limiting examples of suitable ceramics may include carbides of silicon or tungsten; nitrides of boron, titanium, silicon. In some embodiments of the method, the ceramic material comprises yttria stabilized zirconia (YSZ), yttrium aluminum garnet. (Y₃Al₅O₁₂ or YAG), ytterbium oxide (Yb₂O₃), lanthanum cerate, or combinations thereof.

In one embodiment, the feedstock comprises a liquid carrier. Several types of liquid may be used as a carrier, with the choice of liquid. Depending in part upon the particle types and the desired coating characteristics. The liquid carrier may be a solvent or a solution. In the embodiment where the liquid carrier is a solution, particle precursors are present in the solution phase. For example, the liquid carrier may be a nitrate solution.

In the embodiments where the liquid carrier is a suspension medium, the particles are typically suspended within the carrier. In one embodiment, the suspension medium used as a liquid carrier is an organic liquid. Suitable liquids that may be used for feedstock include aprotic polar solvents, protic polar solvents, non-polar solvents or combinations thereof. Examples of suitable aprotic polar solvents include alcohols and ketones. Examples of suitable protic polar solvents include benzene, toluene. Additives may be added to the solvent to stabilize the suspension. Polyethylenimines are examples of stabilizers. The pH of the solution may also be adjusted for stability.

In some embodiments, the liquid carrier comprises water, an alcohol or combinations thereof. In some embodiments, the liquid carrier is de-ionized water. In one embodiment, the process used for application of coating suggests the choice of alcohol system used as the suspension medium. In some instances, the use of alcohol as a liquid carrier is advantageous, as use of alcohol protects the surface from water contamination. The use of an alcohol such as ethanol, instead of de-ionized water, is beneficial since the enthalpy of vaporization of ethanol (0.84 MJ.kg-1) is lower than that of water (2.26 MJ.kg-1). In one embodiment, the liquid used includes an alcohol. The alcohol used may include ethanol, methanol, isopropanol, butanol, cyclo-hexanol or a combination of two or more of these. In one embodiment, the liquid used is ethanol.

In some embodiments, the concentration of the particles in the liquid carrier influences the quality and thicknesses of a surface coating. For example, if the feedstock formed by suspending the particles in the liquid is very dilute, the coating formed by that suspension may become discontinuous. Multiple coating applications may be performed by a dilute suspension to achieve a level of coating thickness. A similar thickness may be achieved by a single coating formed by a comparatively concentrated suspension. Further, the uniformity and the surface roughness of the coating may vary between the coatings formed by a dilute suspension and a concentrated suspension. Furthermore, multiple coating applications by a dilute suspension may not be cost effective due to the multiplicity of process steps and post-coating processes involved. In one embodiment, a comparatively concentrated suspension of ceramic particles in the solvent is used for coating the surface. In some embodiments, the concentration of the particles of the feedstock is less than 50 weight percent. In some other embodiments, the concentration of the particles of the feedstock is less than 30 weight percent. In some other preferred embodiments, the concentration of the particles of the feedstock is less than 20 weight percent.

In some embodiments, the surface texture increases the tortuosity of the surface, which increases the contact angle of a liquid drop on a hydrophobic surface. In other embodiments, the features of the textured surface are sized and configured to create pockets of air between a drop of liquid and the surface, which may reduce the contact area between a drop of liquid and the solid surface, which produces a higher contact angle than would be expected for a smooth surface.

In one or more embodiments where the textured surface is constructed with a material that provides a coating with an inherent hydrophobicity, the deposition of surface energy modification material may be waived. In some embodiments, the textured surface may be constructed with a material that does not inherently provide a hydrophobic coating, and the deposition of a surface energy modification material to form a second layer over the textured surface may be useful to develop a hydrophobic or a super hydrophobic coating.

The feedstock forms a coating on the substrate surface by a thermal spray technique under specific conditions, as described before. The thermal spray method may include flame spray, HVOF, HVAF, arc spray, cold spray or plasma spray, or any other thermal spray method, or methods that allow at least partial melting of the feedstock. In one embodiment, the first layer of coating of the present invention is developed to form a textured surface by suspension plasma spray. The suspension plasma spray provides finely structured layers onto large surfaces under atmospheric conditions.

Several processing parameters may affect the nature of the texture in a resultant coating. The feedstock injection, the characteristics of the suspension, the particle size distribution, the characteristics of the suspended particles, the plasma parameters such as power and gas flow rate, the stand-off distance between the plasma torch and surface, and the torch motion are significant operating parameters among the major extrinsic parameters for suspension plasma spray process to be considered. For example, an injection of a liquid stream may reduce the perturbation of the plasma flow and may permit a homogeneous treatment of the suspension within the plasma jet. The characteristics of the suspension may be significant; for example, ethanol as liquid carrier is advantageous compared to de-ionized water for consuming less energy of vaporization. The particle size distribution may also be significant as the size distribution has an effect on the architecture of the coating, such as distribution of agglomerations or pore-structure. For example, a narrow particle size distribution may promote dense coatings whereas broad particle size distributions may promote porous coatings. The plasma torch power may be significant, as for example, a higher plasma torch power may permit a higher degree of particle melting. The plasma gas flow rate may be significant, for example, a high plasma gas flow rate may permit higher particle velocity. The stand-off distance between the torch and the surface may be significant. For example, a longer stand-off distance between the torch and the surface may permit a cooling of particle before impinging the surface. In another example, the short stand-off distance between the spray gun and the substrate increases the thermal transfer to the substrate and modifies in turn the coating architecture.

The method further comprises applying a surface energy modification material over the textured surface comprising hierarchical structure. The surface energy modification material forms another coating on the textured surface, interchangeably used herein as a second layer. The thermal spray coating, surface energy modification coating or both may be applied to generate a resultant coating, which may form a continuous layer or a discontinuous layer. The surface energy modification material may be applied on the textured surface continuously or discontinuously. The “continuous deposition of surface energy modification material” means the deposition of the material on the substrate surface results in a continuous layer, without leaving any gap. The continuous layer generally provides a completely coated surface. The continuous deposition may provide a complete masking of the surface and results in a fully coated surface. The coating is continuous, as there is no gap or uncoated portion on the textured surface.

The surface energy modification material may be applied by dip coating, brush painting, or spray coating to coat a surface or any method known in the art for applying such materials. In one embodiment, the coating is applied to the surface using brush painting. In some embodiments, a thermal spray coated surface may be re-charged with a surface energy modification material.

In some embodiments, the surface energy modification material is a low surface energy material, wherein the material has a surface energy less than about 35 mJ/m² and typically exhibits hydrophobic behavior. The materials having surface energy less than about 20 mJ/m² are highly hydrophobic and exhibit contact angles with water greater than 90 degrees. Non-limiting examples of low surface energy materials are polytetrafluoroethylene PTFE, polydimethylsiloxane PDMS, paraffin wax, polypropylene, octadecyltrichlorosilane, polyethylene, polystyrene, and fluoroalkysilanes. Application of the low surface energy material may render the textured surface superhydrophobic.

As noted, the low surface energy material is disposed on a textured surface, and produces a hydrophobic coating, or a superhydrophobic coating. In one embodiment, the coated surface is used as a hydrophobic coating for the intended applications. In some embodiments, the coating develops a contact angle of at least about 100° between the coated surface and a static drop of water disposed on the coated surface. In some other embodiments, the hydrophobic coating has a sufficient hydrophobicity to develop a contact angle of at least about 130° between the coated surface and a static drop of water disposed on the coated surface. In some preferred other embodiments, the hydrophobic coating has a sufficient hydrophobicity to develop a contact angle of at least about 150° between the coated surface and a static drop of water disposed on the coated surface, as shown in FIG. 3.

The hydrophobic coating may develop a contact angle hysteresis between an advancing contact angle and a receding contact angle. In some embodiments, the hydrophobic coating has sufficient hydrophobicity to develop a contact angle hysteresis measured between an advancing contact angle and a receding contact angle of less than 20° between the coated surface and a moving drop of water disposed on the coated surface. In some other embodiments, the hydrophobic coating has sufficient hydrophobicity to develop a contact angle hysteresis between an advancing contact angle and a receding contact angle of less than 10° between the coated surface and a moving drop of water disposed on the coated surface. In some embodiments, the hydrophobic coating has sufficient hydrophobicity to develop a contact angle hysteresis between an advancing contact angle and a receding contact angle of less than 5° between the coated surface and a moving drop of water disposed on the coated surface.

In one or more embodiments, the surface energy modification material is applied on the textured surface discontinuously. The term “discontinuously” referred to herein as a resultant coating comprising discontinuous coated-area of surface energy modification material. The surface energy modification material is disposed over the surface, wherein there is a gap between two patches of coatings of surface energy modification material on a single surface. In this embodiment, the gap, as mentioned herein, may be a textured surface which is uncoated by the surface energy modification material. The discontinuous coating structure may lead to a surface with mixed surface characteristics; for instance, as the surface may be hydrophobic, super hydrophobic, or hydrophilic, depending on location.

Different regions of the textured surface may be treated with different surface energy modification material, to create a composite surface comprising two different types of coated areas. A composite surface may be composed of wetting and non-wetting areas. For example, a coating provides alternating wetting and non-wetting areas to create wetting or non-wetting interfaces using two or more different coating materials. Such interfaces may promote different functionality, such as oil-water separation, as shown in FIG. 8.

The low surface energy material, in some embodiments, comprises an inorganic material, a fluorinated material, a polymer, or combinations thereof. The low surface energy material may comprise a material that is selected from the group consisting of DLC, fluorinated DLC, chromium nitride, titanium nitride, zirconium nitride, hafnium carbide, chromium carbinde, titanium carbide, zirconium carbide, hafnium carbide, lanthanum cerate, neodymium cerate, praseodymium cerate, ytterbium oxide, cerium-doped yttrium aluminum garnet, nickel, cobalt, and combinations thereof.

In one embodiment, the low surface energy material may comprise fluorinated material. The fluorinated material may comprise a fluorosilane or a fluoroalkylsilane. In some embodiments, the polymer comprises at least one selected from the group consisting of silicones, fluoropolymers, urethanes, acrylates, epoxies, polysilazanes, aliphatic hydrocarbons, polyimides, polycarbonates, polyether imides, polystyrenes, polyolefins, polypropylenes, polyethylenes and combinations thereof. In some embodiments, the low surface energy material comprises fluoropolymers, siloxanes, silane, alkyl silane, fluoro-silane, fluoro alkyl silane or combinations thereof.

Non-limiting examples of a fluoro-alkylsilane includes tridecafluoro 1,1,2,2-tetrahydrofluoro octyl trichlorosilane, and heptadecafluoro-1,1,2,2-tetrahydrodecyl trimethoxysilane. In one embodiment, the fluoro-silane may comprise a heptadecafluoro-1,1,2,2-tetrahydrodecyl trimethoxysilane. In one embodiment, the surface energy modification material comprises a solvent and a fluoro-silane. The number of fluorine atoms present and the length of the polymeric back bone chain of the fluoro-silane may play a role in the effective hydrophobicity of the coating formed by the fluoro-silane solution.

In one embodiment, the surface energy modification coating material includes heptadecafluoro-1,1,2,2-tetrahydrodecyl trimethoxysilane (also known as FAS). This compound has 17 fluorine atoms present in the compound formula that imparts a high hydrophobicity to the applied coating. In one embodiment, the amount of FAS present in the solution is in a range from about 2 molar percent about 80 molar percent of the coating material. In one embodiment, the amount of FAS present in the coating solution is about 2 molar percent of the solution. In one embodiment, a 4 molar percent heptadecafluoro-1,1,2,2-tetrahydrodecyl trimethoxysilane in alcohol provides optimal performance. The 80 molar percent heptadecafluoro-1,1,2,2-tetrahydrodecyl trimethoxysilane may also ensure minimal amount of fluorine loss during the life of the coating in service. In one embodiment of the method, the FAS is added to the solution at room temperature and mixed over a span of time before application.

In one embodiment, the coating applied using the surface energy modification solution on a surface undergoes a hydrolysis condensation reaction forming an organo-metallic polymer hybrid coating over the surface.

In a further embodiment, the coating applied over the surface is partially converted through heat-treatment to further increase the functionality of the low-energy material. Generally heat-treatment of the applied coating to a high temperature and extended time results in fluorine loss and therefore decrease in the hydrophobic nature of the coating. For example, heat-treatment of the coating at temperatures in excess of about 350° C. for more than 5 minutes may result in fluorine loss from the coating and hence lead to performance degradation as a hydrophobic coating.

Thickness of the coating may depend upon the nature of the environment and the application envisioned for the article. For example, in a heat exchanger application, the coating is typically designed to minimize thermal resistance between the environment and the substrate while achieving a practical service lifetime. Determination of the coating thickness for a given application is within the knowledge of one skilled in the art. One or more intervening layers of coatings may be applied for any reason, such as to achieve desired levels of adhesion between a substrate and a coating. Requirement of various intervening layers of coatings may depend on the nature of the coating materials involved and the selected methods for processing the materials.

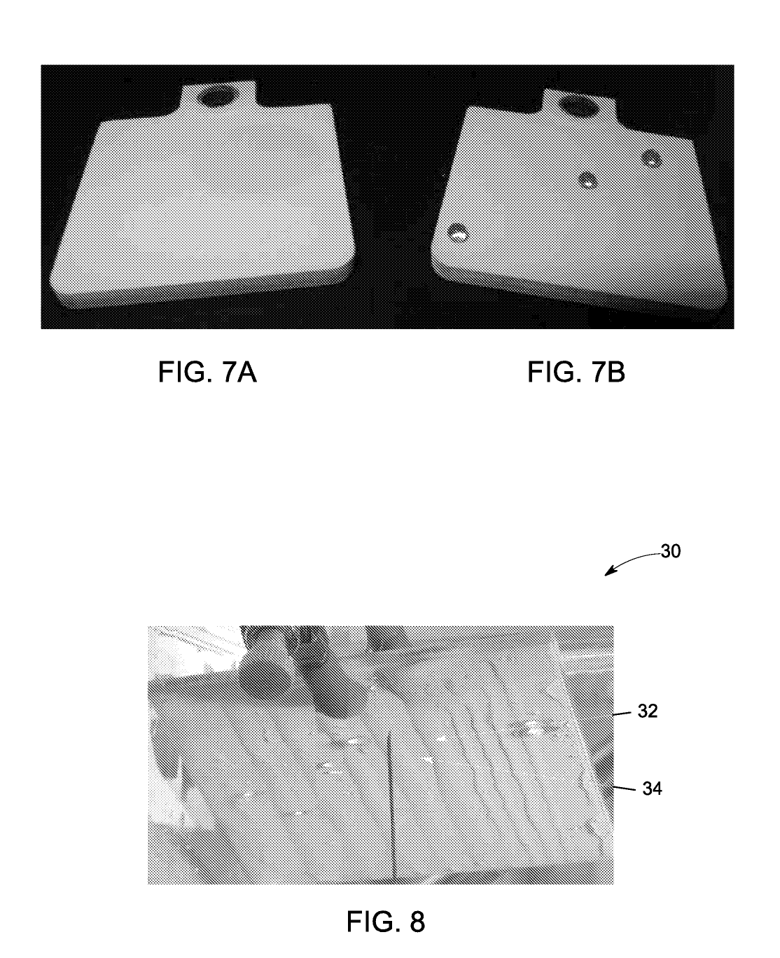

The low surface energy modification material coated surface provides a surface which is resistant to wetting by liquids, as shown in FIG. 7B. The coating with desired surface properties, as described above, offer multiple useful applications where resistance to wetting by liquids is required. Many applications would benefit from the use of wetting-resistant surfaces and components having these surfaces that are resistant to wetting by liquid droplets. For example, aircraft components, such as airframe and engine components, and wind turbine components are susceptible to icing due to super-cooled water that remains in contact with the surface while the droplets freeze and accumulate as an agglomerated mass of ice. This may reduce the efficiency of the components and eventually may cause damage to these components. The coated surface may help to reduce the adhesion of ice on the surface.

An article comprising a component having a coated surface 25 is provided herein (FIG. 2B). The coated surface comprises a first layer 26 comprising a textured surface with hierarchical structure and a second layer 27 comprising a surface energy material disposed on the textured surface 26. The first layer 26 comprises a textured surface comprising a hierarchical structure disposed on article 29. The hierarchical structure comprises agglomerations of at least partially melted and solidified particles derived from a feedstock with individual at least partially melted and solidified particles derived from the feedstock disposed on a surface of the agglomerations. In one or more embodiments, the second layer 27 forms a hydrophobic coating and wherein the hydrophobic coating has a sufficient hydrophobicity to develop a contact angle of at least about 100° between the coated surface and a static drop of water disposed on the coated surface. In certain embodiments, the contact angle is greater than 130°, and in particular embodiments, the contact angle is greater than 150°. In one embodiment, the second layer forms a hydrophobic coating and wherein the hydrophobic coating has a sufficient hydrophobicity to develop a contact angle of at least about 150° between the coated surface and a static drop of water disposed on the coated surface.

In one or more embodiments, the second layer forms a hydrophobic coating and wherein the hydrophobic coating has a sufficient hydrophobicity to develop a contact angle hysteresis of less than about 20° between the coated surface and a moving drop of water disposed on the coated surface. In certain embodiments, the contact angle hysteresis is less than 10°, and in particular an embodiment, the contact angle is less than 5°. In one embodiment, the second layer forms a hydrophobic coating and wherein the hydrophobic coating has a sufficient hydrophobicity to develop a contact angle hysteresis of less than about 5° between the coated surface and a moving drop of water disposed on the coated surface.

As used herein, the term “surface” is not construed to be limited to any shape or size, as it may be a layer of material, multiple layers or a block having at least one surface of which the wetting resistance is to be modified. In one embodiment, the surface is an outer surface of the tubes of a condenser. In an alternate embodiment, the surface is an inner surface of the tubes of a condenser. In one embodiment, the surface on which the coating is applied is a metal surface; “metal” as used herein includes alloy phases. Exemplary metals include steel, stainless steel, nickel, titanium, aluminum or any alloys thereof. In some embodiments, the metal includes a titanium-based alloy, an aluminum-based alloy, a cobalt-based alloy, a nickel-based alloy, an iron-based alloy or any combinations thereof. In some other embodiments, the surface comprises ceramic material. In some other embodiments, the surface is made of polymer.

In some embodiments, it is beneficial to have a steam condenser with wetting-resistant surfaces. Condensers with hydrophobic surfaces have a resistance for wetting by water. This behavior may alter the mode of steam condensation on the surface. On hydrophilic surfaces, condensation of steam to water results in film formation. These water films provide significant resistance to heat transfer. However, on some hydrophobic surfaces, and especially on certain superhydrophobic surfaces, water droplets are nucleated from steam, grow to critical sizes and may get shed as droplets resulting in “drop wise” condensation. This condensation mode is more efficient in transferring the latent heat of condensation. Consequently, the application of hydrophobic coatings on steam condensers may result in heat transfer enhancement. Contact angle of water and its hysteresis on a surface directs the drop shedding behavior of that surface and consequently the heat transfer enhancement.

A condenser is used, for instance, to condense vapors by transferring heat from the hot vapor and a cooling fluid, such as is used in chemical processing, water desalination, and power generation and is an example of an embodiment of the present coating and materials described above. As noted above, many of the compositions applied in embodiments of the present invention promote drop wise condensation, so that liquid is shed from the surface in small drops rather than in larger sheets. In particular embodiments, the article is a component of a power plant condenser. The condenser includes tubes with an outer surface coated with the described coating to promote drop-wise condensation of steam, leading to enhanced heat transfer.

Certain embodiments of the present invention may reduce the formation, adhesion, and/or accumulation of ice on surfaces. Icing is a significant problem for various applications, for example aircraft engines, wind turbine blades, as the build-up of ice on various components reduces the efficiency and increases the safety risks of operations. Icing takes place when a water droplet (sometimes supercooled) impinges upon the surface of an article, such as an aircraft component or a component of a turbine assembly (for example, a gas or wind turbine), and freezes on the surface. The build-up of ice in aircraft engines, on turbine components, and other equipment exposed to the weather, increases safety risks and generates costs for periodic ice removal operations. Certain embodiments of the present invention include an aircraft that comprises the articles and materials described above; a component of such an aircraft suitable to serve as the embodied article may include, for example, a wing, tail, fuselage, or an aircraft engine component. The coating primarily provides article with an increased resistance to “icing:” the formation and accretion of ice through deposition and freezing of super-cooled water droplets on a surface.

As other components exposed to the weather are also adversely affected by ice and/or water accumulation, other embodiments may include, for instance, components of other items exposed to the weather, such as power lines and antennas. The ability to resist wetting may benefit a host of components that are so exposed, and the examples presented herein should not be read as limiting embodiments of the present invention to only those named applications.

### EXAMPLE

The following example illustrates methods, materials and results, in accordance with specific embodiments, and as such should not be construed as imposing limitations upon the claims.

### Preparation of Feedstock for Thermal Spray Coating

The feedstock was prepared by suspending a plurality of ceramic particles in a solvent. The suspension was wet milled to achieve the desired particle size distribution, and further diluted with more solvent to achieve desired solid particle concentration. Up to 0.1 weight % of polyethyleneimine (purchased from Alfa Aesar) was added to stabilize the suspension. The ceramic materials used herein were Yttria (8 weight %)-stabilized Zirconia, referred to herein as 8YSZ, Yttria (13 weight %)-stabilized Zirconia, referred to herein as 13YSZ, Yttium Aluminum Garnet (Y₃Al₅O₁₂), referred to herein as YAG, Ytterbium oxide (Yb₂O₃). YSZ was purchased from Unitec, YAG was purchased from Treibacher, Ytterbium oxide was purchased from Alfa Aesar. Ethyl alcohol, denatured (A407) purchased from Fisher Scientific was used herein as a solvent. The concentration of solid particles in the suspension was between 5 to 20 wt %.

Different materials were used for developing textured surface by suspension plasma spray (SPS), wherein the concentration of the precursor material was different. The particle distribution of the precursor material was also different, as shown in Table 1.

TABLE 1
The particle distribution of the feedstock material

| | | | Particle size distribution | | |
|---|---|---|---|---|---|
| Feedstock | | Solid particle | D₁₀ | D₅₀ | D₉₀ |
| Identification | Material | conc.(wt %) | (μm) | (μm) | (μm) |
| 8Y | 8YSZ | 20 | 0.59 | 1.82 | 3.4 |
| 13Y | 13YSZ | 10 | 0.34 | 0.58 | 1.36 |
| 13Y-20 | 13YSZ | 20 | 0.34 | 0.51 | 0.86 |
| 13Y-F | 13YSZ | 10 | 0.11 | 0.17 | 0.33 |
| YAG | YAG | 5 | 0.58 | 1.71 | 3.92 |
| Yb | Yb₂O₃ | 10 | 0.26 | 0.47 | 12.1 |

The feedstock was fed into a thermal spray torch and was applied on the desired surface, as described in FIG. 2 A. The precursor material (feedstock) was applied using SPS. SPS was carried out based on two plasma guns: the Axial III gun (Northwest Mettech Corp, BC, Canada) and the 9 MB gun (Sulzer Metco AG, Wohlen, Switzerland). Feedstock injection was axial for the Axial III gun, and radial for the 9 MB gun. The axial injection means injecting the feedstock material along the axis of the plasma plume. The radial injection means injecting the feedstock material across the axis of the plasma plume, the injection angle being within 60 degrees of the normal of the axis of the plasma plume. In the examples described below where radial injection was used, the injection was normal to the axis of the plasma plume. Different gun parameters were optimized and used for SPS. A “stand-off” distance, that is the distance between the nozzle of the torch and the substrate-surface to be coated, was also optimized per application requirement. Stand-off distances were between 3.5 cm and 9 cm. The precursor material was applied using the torch under various conditions as mentioned in Table 2 below.

TABLE 2
Conditions for thermal spray coating

| | | Feedstock | Power |
|---|---|---|---|
| Condition | Gun | injection | (kW) |
| A | Axial III | Axial | 88.2 |
| B | Axial III | Axial | 91.8 |
| C | 9MB | Radial | 34.3 |
| D | 9MB | Radial | 43.9 |
| E | 9MB | Radial | 41.9 |

### Preparation of a Low Surface Energy Modification Material

Materials: The material used for coating was fluorosilane. Vacuum desiccator with polymer shell was used, which has adequate size to hold at least 10-15 samples. Pyrex petri culture dish (100×10 mm) was purchased from Fisher Scientific, part number 08-746B, vacuum safe tubing from Fisher Scientific, part number 1417620, vacuum pump or vacuum source from in house lab vacuum, and 2 ml pipette were purchased from Fisher Scientific, part number 568228B. Heptadecafluoro-1,1,2,2-tetrahydrodecyl trimethoxysilane, C₁₃H₁₃F₁₇O₃S₁ was purchased from Gelest Inc., product code SIH5841.5.

A desiccator was set up with a petri dish centered on the floor. A support table was placed close to the desiccator. 1 ml of FAS solution was carefully pipette out and added into the petri dish. The samples were arranged in the desiccator such that the surface to be treated was facing up. A vacuum source was used to achieve lower than 30 inHg pressure. The vacuum source was removed after reaching the desired pressure inside the desiccator and ensured that the desiccator remained sealed. The sample was dried under vacuum for 8 to 24 hrs. For this example, the sample was dried for 18 hrs in desiccator under vacuum condition.

Teflon AF powder was used for some of the experiments and was treated as mentioned in Example 1. The dried Teflon AF powder was dissolved in perfluorinated solvents, such as FC 72 (3M concentration). The dissolution time ranged from a few hours to a few days. The Teflon liquid film was then be spin-coated onto the target surface. After application of the Teflon film on the surface, the surface was then heated above the glass transition temperature of the Teflon and the boiling point of the solvent, typically between 175-300° C., for 15-20 minutes. This heat treatment removed the solvent and produced a Teflon film coated on the surface. The thickness of the film varied from different the application techniques, such as spin speed and time for spin coating, and the concentration of Teflon in the initial solution.

### Example 1

### Preparation of Superhydrophobic Coatings

Stainless steel substrate of dimension 1″×3″×0.125″ were coated with feedstock materials from Table 1, deposited using SPS conditions listed in Table 2 at different stand-off distances. All coated substrates were further coated with fluorosilane, as described previously. A water droplet on a fluorosilane coated textured surface formed a static contact angle of >150°, as shown in FIG. 3. Feedstock, SPS condition and stand-off distance, are shown in Table 3.

TABLE 3
Sample coated with SPS coating and fluorosilane

| Sample | Condi- | Feedstock | Stand-off |
|---|---|---|---|
| Identification | tion | identification | distance (cm.) |
| 1 | A | 8Y | 8.9 |
| 2 | A | 13Y | 8.9 |
| 3 | A | 13Y-F | 8.9 |
| 4 | C | YAG | 6.4 |
| 5 | C | YAG | 6.4 |
| 6 | D | YAG | 5.1 |
| 7 | E | YAG | 5.1 |
| 8 | D | Yb | 6.4 |
| 9 | E | Yb | 5.1 |
| 10 | D | 13Y | 3.8 |
| 11 | E | 13Y | 6.4 |
| 12 | A | YAG | 5.1 |
| 13 | B | YAG | 5.1 |

Contact angle and contact angle hysteresis were measured for samples listed in Table 3. Contact angle and contact angle hysteresis were measured using a VCA Optima system, AST products Inc. (Billerica, Mass.) with 8 μL droplets of de-ionized water. The measured contact angle and contact angle hysteresis are shown in Table 4. For reference, contact angle for fluorosilane deposited onto a smooth silicon wafer was also measured and is shown in Table 4.

TABLE 4
Contact angle and contact angle hysteresis
measure on coated samples

| | Contact angle (degrees) | | Contact angle |
|---|---|---|---|
| Sample | | Standard | hysteresis (degrees) |
| Identification | Mean | deviation | Mean |
| 1 | 152.5 | 2.0 | 5.0 |
| 2 | 153.7 | 0.8 | NA |
| 3 | 151.9 | 1.0 | 8.7 |
| 4 | 148.7 | 1.6 | 10.3 |
| 5 | 153.3 | 0.4 | 1.4 |
| 6 | 145.3 | 7.0 | 13.7 |
| 7 | 157.4 | 0.4 | NA |
| 8 | 155.6 | 0.8 | 7.9 |
| 9 | 157.9 | 1.3 | NA |
| 10 | 158.8 | 1.2 | 4.5 |
| 11 | 154.6 | 1.3 | 6.9 |
| 12 | 111.6 | 4.5 | NA |
| 13 | 106.2 | 7.4 | NA |
| Smooth | 106.9 | 1.6 | NA |
| fluorosilane A | | | |
| Smooth | 115.1 | 1.5 | NA |
| fluorosilane B | | | |

FIGS. 4 A, B, C and D show scanning electron microscope images of a coating deposited with condition 11 listed in Table 3. The coatings were deposited using condition 11 of Table 3 and further coated with fluorosilane to form a superhydrophobic surface. The coatings show contact angle hysteresis less than 10 degrees, as shown in Table 4. FIGS. 4A and 4B show the coating texture as seen from a top-down view at different magnifications. FIGS. 4C and 4D show images of a polished cross-section of the coating at different magnifications. FIGS. 4A, 4B, 4C and 4D illustrate the hierarchical structure comprising agglomeration of at least partially melted and solidified ceramic particles with individual at least partially melted and solidified particles derived from the feedstock disposed on a surface of the agglomeration.

FIGS. 5 A, B and C show scanning electron microscope images. Coating is deposited using conditions for sample 11 (as listed in Table 3) and further coated with fluorosilane to form a hydrophobic surface. However, coating deposited with conditions for sample 12 listed in Table 3 and further coated with fluorosilane did not form a surface with same hydrophobicity, as shown in Table 4. The coating for sample 12 showed contact angle similar to that measured on fluorosilanated smooth samples B, as shown in Table 4. FIGS. 5A and 5B show the coating texture as seen from a top-down view at different magnifications. FIGS. 5A, 5B illustrate that the coating structure is primarily composed of fully flattened particles that had formed lamellae. The formed structure does not exhibit desired hierarchical structure comprising agglomeration of at least partially melted and solidified ceramic particles with individual at least partially melted and solidified particles of the feedstock disposed on the agglomerations. This coating is an example where the spray conditions, such as stand-off distance, were not appropriated to generate a highly textured super hydrophobic coating.

### Example 4

### Coating of the Condenser Tubes

A method of coating condenser tubes is described below. The tube was visually inspected inside and outside for defects and checked for straightness. The tubes were coated with the deposition condition 11, as listed in Table 3. Three tubes were coated, wherein Tube 1 was coated with 3 μm of the SPS coating, tube 2 was coated with 13 μm of the SPS coating, and tube 3 was coated with 33 μm of the SPS coating. All SPS coated tubes were further coated with fluorosilane, as described previously.

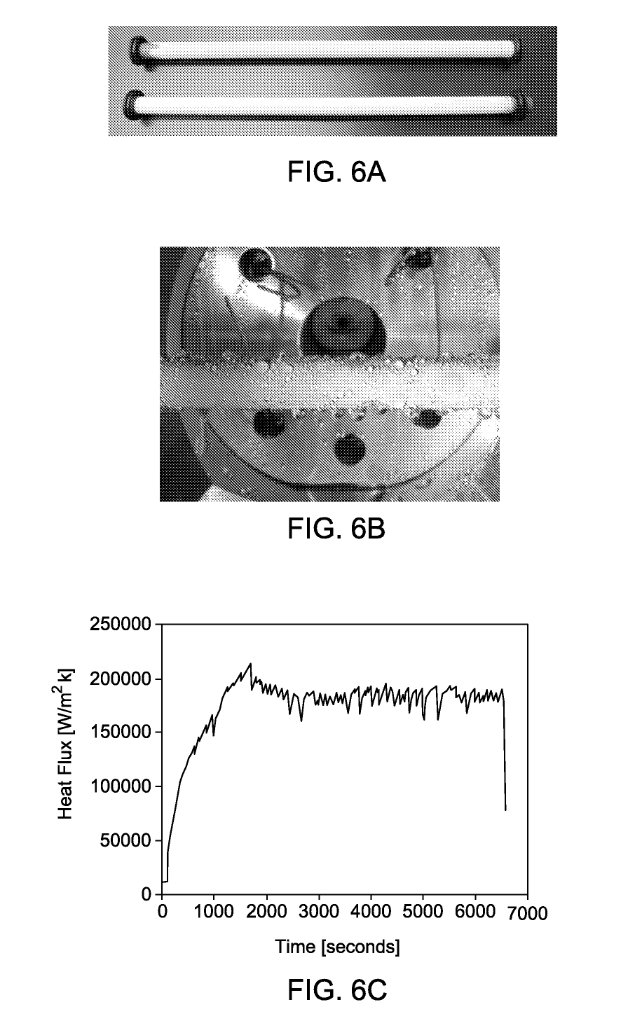

Both high contact angle and low hysteresis may be desirable for efficient heat transfer through drop-wise condensation of steam. Uncoated steel surfaces, which show film-wise condensation, had contact angles as high as 80 degrees with hysteresis of about 60 degrees. The coatings of some of the embodiments of the present invention had contact angles of greater than about 150 degrees with hysteresis lower than about 10 degrees. FIG. 6A shows coated condenser tubes, FIG. 6B illustrates drop wise condensation of liquid over the coated surface of the tube and FIG. 6C shows the heat flux data generated on drop wise condensation method, respectively. The data (FIG. 6C) shows up to 1.8× heat transfer enhancement over film-wise condensation. The overall heat enhancement and coating thickness are presented in Table 5. FIG. 6C shows the stable heat transfer characteristics (>1 hour) of the drop-wise condensation achieved using this coating. The drop in heat flux at 6500 seconds is due to test shut-down and not failure of the coating.

TABLE 5
The overall heat enhancement and coating
thickness for different tubes

| Tube | Coating thickness | Overall heat |
|---|---|---|
| ID | (μm) | enhancement |
| 1 | 3 | 1.8 |
| 2 | 13 | 1.5 |
| 3 | 33 | 1.4 |

### Example 5

### Reduced Wetting Behavior

A textured surface coated with a surface energy modification material, FAS, was subjected to an experiment to show reduced wetting of liquid. The experiment was performed under three different conditions. In one aspect, only a textured surface was used to observe wetting behavior of liquid (FIG. 7A). In the test sample, the substrate was coated with a textured coating as well as FAS coating (FIG. 7B) to observe wetting-resistant behavior of the surface. It was observed that the water spread over the untreated coating, as shown in FIG. 7A. The coated surface (FIG. 7B) forms a static contact angle of about 152°. The contact angle hysteresis was less than 5°.

### Example 6

### Reduced Ice Adhesion

Ice adhesion was measured on the textured surfaces described above. Reduction in ice adhesion was demonstrated on the superhydrophobic surface and the data is presented in Table 6. The data demonstrates that the surface coated with a superhydrophobic coating (textured+FAS) had improved property with respect to its ice adhesion and the ice adhesion decreased 2× fold compared to untreated coating (textured only).

TABLE 6
Ice adhesion on a coated and an uncoated surface

| | Adhesion of |
|---|---|
| Coating | ice (psi) |
| Textured only | 44 |
| Textured + FAS | 20 |

### Example 7

### Composite Coating on a Surface

A textured surface was discontinuously coated with a surface energy modification material, FAS, to form a composite surface. The composite surface had a textured area as well as FAS coated area. The textured area was hydrophilic and the FAS coated area was hydrophobic. The experiment was performed to show that the composite surface had a composite interface which helped in separating oil and water on the same surface, as shown in FIG. 8. FIG. 8 illustrates the composite surface 30 with an interface which helped in separating oil 32 and water 34 on the same surface. It was observed that the water was adhered on the non-FAS treated area, which is typically a hydrophilic area. The surface showed adhesion of oil over the FAS-coated area on the same surface.

While the invention has been described in detail in connection with only a limited number of embodiments, it should be readily understood that the invention is not limited to such disclosed embodiments. Rather, the invention may be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method comprising:
feeding a feedstock to a thermal spray torch, the feedstock comprising a liquid;
disposing the feedstock on a substrate by thermal spray under conditions selected to produce a textured surface comprising a hierarchical structure, wherein the hierarchical structure comprises agglomerations of at least partially melted and solidified particles derived from the feedstock with individual at least partially melted and solidified particles derived from the feedstock disposed on a surface of the agglomerations; and
applying a surface energy modification material over the textured surface.

2. The method of claim 1, wherein the feedstock further comprises a plurality of particles disposed in the liquid, wherein at least 50% of the particles in the plurality have a diameter less than about 5 microns.

3. The method of claim 1, wherein the feedstock further comprises a plurality of particles disposed in the liquid, wherein at least 50% of the particles in the plurality have a diameter less than about 2 microns.

4. The method of claim 2, wherein the feedstock comprises a ceramic, a metal, a polymer, or combinations thereof.

5. The method of claim 4, wherein the ceramic material comprises an oxide, a nitride, a carbide, or combinations thereof.

6. The method of claim 4, wherein the ceramic comprises yttria stabilized zirconia (YSZ), yttrium aluminum garnet (Y₃Al₅O₁₂ or YAG), ytterbium oxide (Yb₂O₃) or combinations thereof.

7. The method of claim 1, wherein a size of the agglomerations is in a range from about 5 μm to 50 μm.

8. The method of claim 1, wherein the agglomerations have a mean height H above a mean surface level of the textured surface of at least about 1 micron.

9. The method of claim 1, wherein a size of the individual at least partially melted and solidified particles disposed on the surface of the agglomerations is less than 5 μm.

10. The method of claim 1, wherein the agglomerations further comprise at least fully melted and re-solidified particles.

11. The method of claim 1, wherein the agglomerations further comprise one or more pores in a range of about 0 to 90%.

12. The method of claim 1, wherein the surface energy modification material is applied on the textured surface discontinuously.

13. The method of claim 1, wherein the surface energy modification material is a low surface energy material.

14. The method of claim 13, wherein the low surface energy material produces a hydrophobic coating on the textured surface to form a contact angle of more than 100°.

15. The method of claim 14, wherein the hydrophobic coating has a sufficient hydrophobicity to develop a contact angle of at least about 130° between the coated surface and a static drop of water disposed on the coated surface.

16. The method of claim 14, wherein the hydrophobic coating has a sufficient hydrophobicity to develop a contact angle of at least about 150° between the coated surface and a static drop of water disposed on the coated surface.

17. The method of claim 14, wherein the hydrophobic coating has a sufficient hydrophobicity to develop a contact angle hysteresis between an advancing contact angle and a receding contact angle of less than 20° between the coated surface and a moving drop of water disposed on the coated surface.

18. The method of claim 13, wherein the low surface energy material comprises an inorganic material, a fluorinated material, a polymer, or combinations thereof.

19. The method of claim 18, wherein the fluorinated material comprises a fluorosilane or a fluoroalkylsilane.

20. The method of claim 18, wherein the polymer comprises at least one material selected from the group consisting of silicones, fluoropolymers, urethanes, acrylates, epoxies, polysilazanes, aliphatic hydrocarbons, polyimides, polycarbonates, polyether imides, polystyrenes, polyolefins, polypropylenes, and polyethylenes.

21. The method of claim 13, wherein the low surface energy material comprises a fluoropolymer, siloxane, silane, alkyl silane, fluoro-silane, fluoro alkyl silane or combinations thereof.

22. The method of claim 21, wherein the fluoro-silane comprises heptadecafluoro-1,1,2,2-tetrahydrodecyl trimethoxysilane.

23. The method of claim 1, wherein the disposing step comprises disposing the feedstock on a substrate by suspension plasma spray process.

24. The method of claim 1, wherein the liquid carrier is an alcohol, water, or a combination thereof.

25. The method of claim 1, wherein a concentration of the particles disposed in the liquid carrier is up to about 50 wt %.

26. A method of coating a substrate, comprising:
feeding a feedstock to a thermal spray torch, the feedstock comprising a liquid carrier and a plurality of ceramic particles disposed in the carrier, wherein at least 50% of the particles in the plurality have a diameter less than about 2 microns;
disposing the feedstock on the substrate by a suspension plasma spray process under conditions selected to produce a textured surface comprising a hierarchical structure, wherein the hierarchical structure comprises agglomerations of at least partially melted and solidified ceramic particles derived from the feedstock with individual at least partially melted and solidified particles derived from the feedstock disposed on a surface of the agglomerations; and
applying a low surface energy modification material over the textured surface.

27. An article, comprising:
a component having a coated surface comprising a coating, wherein the coating comprises
a first layer, wherein the first layer comprises a textured surface comprising a hierarchical structure comprising agglomerations of at least partially melted and solidified particles derived from a feedstock with individual at least partially melted and solidified particles derived from the feedstock disposed on a surface of the agglomerations; and
a second layer, wherein the second layer comprises a low surface energy material disposed on the textured surface.

28. The article of claim 27, wherein the second layer is a hydrophobic coating has a sufficient hydrophobicity to develop a contact angle of at least about 150° between the coated surface and a static drop of water disposed on the coated surface.

29. The article of claim 27, wherein the coated surface comprises both hydrophobic and hydrophilic regions.

30. The article of claim 27, wherein the coating has a thickness in a range from about 300 nanometers to 5 millimeters.

31. The article of claim 27, wherein the component is a condenser tube.
